(19) United States
(12) Patent Application Publication
(10) Pub. No.: US 2021/0165378 A1
(43) Pub. Date: Jun. 3, 2021

(54) PORTABLE EQUIPMENT SMART SYSTEM

(71) Applicant: Oladayo Luke, Severn, MD (US)

(72) Inventor: Oladayo Luke, Severn, MD (US)

(21) Appl. No.: 16/701,645

(22) Filed: Dec. 3, 2019

(51) Int. Cl. G05B 19/042

(52) U.S. Cl. CPC G05B 19/0421; G05B 2219/2231; G05B 2219/2642

(57) ABSTRACT

The present invention is an Equipment Smart System which is applicable to a majority of non-smart portable equipment. It presents a universal control system which can be plugged into majority of non-smart portable equipment. It has multiple component interfaces but same functionality to suite different types of equipment. One way the present system can be installed on a user's device (such as Personal Computer, Laptop, Tablet, smart phone etc.) in the form of Application software. The proposed system is also applicable to majority of non-smart portable equipment.

### CROSS-REFERENCE TO RELATED APPLICATIONS

No related applications are previously filed.

### FIELD OF THE INVENTION

The present invention is an Equipment Smart System which is applicable to a majority of non-smart portable equipment. It presents a universal control system which can be plugged into majority of non-smart portable equipment. It has multiple component interfaces but same functionality to suite different types of equipment. The further components of the system are discussed in the Application below.

### DESCRIPTION OF THE RELATED ART

The US Patent Application US20190003137A1 talks about Automatic Moving Snow Removal Device wherein an automatic moving snow removal device including a moving module, driving a snow blower to move; a working module, including a working motor and a snow throwing mechanism driven by the working motor, the snow throwing mechanism is driven by the working motor to collect accumulated snow and inclusions on the ground and throw out of the snow throwing mechanism; and a control module, configured to control a rotary speed of the working motor to cause a speed when the inclusions depart from the snow throwing mechanism is not higher than 41 m/s is disclosed.

While the cited prior art talks about Automatic Moving Snow Removal Device which does not have a universal control device whereas the present invention is an Equipment Smart System which is applicable to a majority of non-smart portable equipment. It presents a universal control system which can be plugged into majority of non-smart portable equipment. It has multiple component interfaces but same functionality to suite different types of equipment.

The US Patent Application US20150128547A1 talks about Lawn mower with remote control wherein an autonomous robot, such as an autonomous lawn mower, comprises at least one camera for obtaining at least one input image, a communication interface for transmitting the input image and receiving a remote control instruction, a control unit for controlling an operation of the autonomous robot, and wherein the control unit is adapted to control the operation at the autonomous robot in response to the received remote control instruction is disclosed.

While the cited prior art talks about Lawn mower with remote control wherein an autonomous robot, such as an autonomous lawn mower, comprises at least one camera for obtaining at least one input image, a communication interface for transmitting the input image and receiving a remote control instruction, a control unit for controlling an operation of the autonomous robot which does not have a universal control device whereas the present invention is an Equipment Smart System which is applicable to a majority of non-smart portable equipment. It presents a universal control system which can be plugged into majority of non-smart portable equipment. It has multiple component interfaces but same functionality to suite different types of equipment.

The US Patent Application US20190120234A1 talks about Water pumping control device and system wherein a water pumping control device may include a primary power source and a secondary power source. The primary power source may be configured to provide a primary power input to a processing unit, and the secondary power source may be configured to provide a secondary power input to the processing unit. A primary pump and a secondary pump may be in communication with the processing unit, and the primary pump and the secondary pump may each be variable in speed. The primary pump and the secondary pump may each be in fluid communication with a sump so that when a pump is activated, the pump may remove water from the sump. A water level sensor may be in communication with the processing unit, and the water level sensor may be configured to provide a water level input describing a water level in the sump to the processing unit is disclosed.

While the cited prior art talks about water pumping control device and system wherein a water pumping control device may include a primary power source and a secondary power source. The primary power source may be configured to provide a primary power input to a processing unit, and the secondary power source may be configured to provide a secondary power input to the processing unit. A primary pump and a secondary pump may be in communication with the processing unit, and the primary pump and the secondary pump may each be variable in speed which does not have a universal control device whereas the present invention is an Equipment Smart System which is applicable to a majority of non-smart portable equipment. It presents a universal control system which can be plugged into majority of non-smart portable equipment. It has multiple component interfaces but same functionality to suite different types of equipment.

The US patent application U.S. Pat. No. 7,677,344B2 talks about Hybrid remote control lawn mower wherein a hybrid remote control lawn mower that includes embodiments to provide use in all seasons. These embodiments include, a wagon, a spreader, a dethacher, a leaf collector, a leaf blower, a lawn trimmer, a lawn edger, an edger, a hedge trimmer, a snowplow blade, a snow blower, etc. The hybrid remote control lawn mower allows an operator to stay at a safe distance away from the hybrid remote control lawn mower in dangerous places such as on steep hills is disclosed.

While the cited prior art talks about Hybrid remote control lawn mower wherein a hybrid remote control lawn mower that includes embodiments to provide use in all seasons. These embodiments include, a wagon, a spreader, a dethacher, a leaf collector, a leaf blower, a lawn trimmer, a lawn edger, an edger, a hedge trimmer, a snow plow blade, a snow blower, etc and does not have universal device controller and mobile App and the specific controllers whereas the present invention is an Equipment Smart System which is applicable to a majority of non-smart portable equipment. It presents a universal control system which can be plugged into majority of non-smart portable equipment. It has multiple component interfaces but same functionality to suite different types of equipment.

### BRIEF DESCRIPTION OF THE DRAWINGS

FIG. 1 represents block diagram of the portable equipment smart system.

FIG. 2 represents the exploded view that shows the components of the portable equipment smart system adapter.

FIG. 3 illustrate the perspective view of oil and gas sensor.

FIG. 4 represents the front and perspective view of chock.

FIG. 5 represents the front view of the fuel gate.

FIG. 6 represents the internal view of the on off switch.

FIG. 7 represents the systematic workflow of the invention and its applications.

FIG. 8 represents the front, side, rear, bottom and the perspective view of the equipment carrier.

### DETAILED DESCRIPTION OF THE DRAWINGS

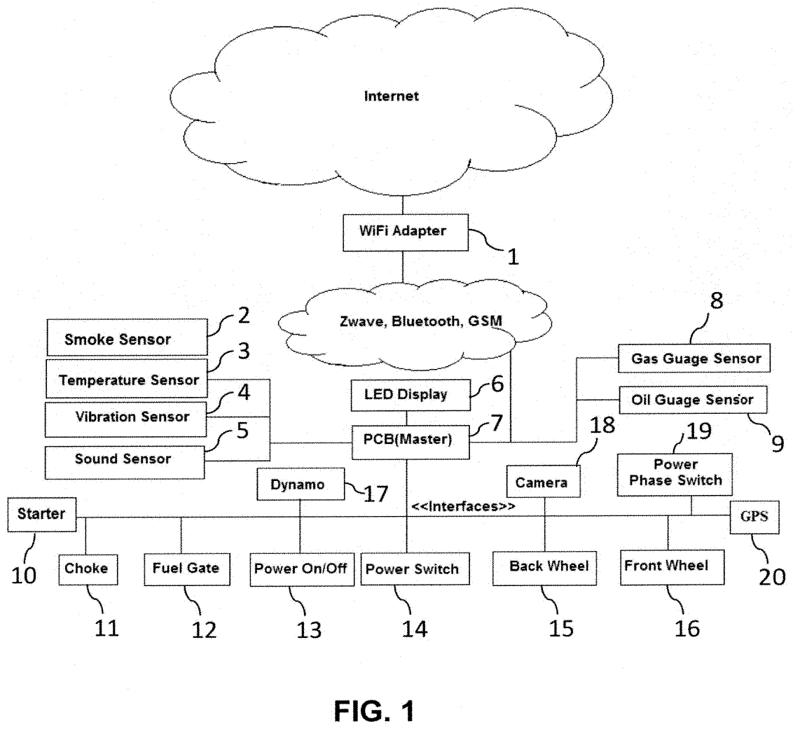

FIG. 1 represents block diagram of the entire system. FIG. 1 further includes Wifi sensor/adapter 1, smoke sensor 2, temperature sensor 3, vibration sensor 4, sound sensor 5, LED display 6, PCB (master) 7, gas gauge sensor 8, oil gauge sensor 9, starter 10, choke 11, fuel gate 12, power on/off 13, power switch 14, back wheel 15, front wheel 16, dynamo 17, camera 18, power phase switch 19, GPS 20.

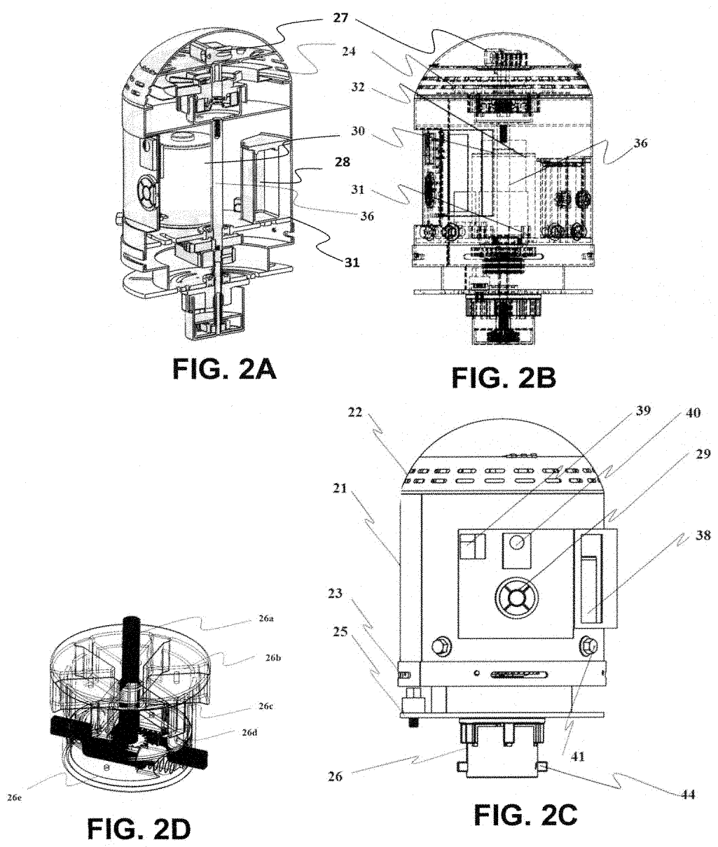

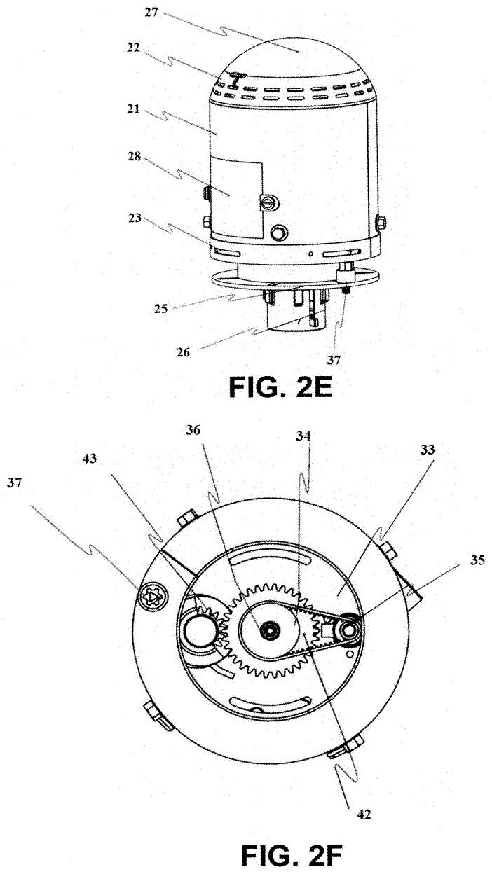

FIG. 2A illustrates the internal and exploded view that shows the components of the portable equipment smart system adapter. Smart system in a disassembled way that displays the hidden parts of invention, which further includes a pull cord pulley 24 recoil starter handle 27, battery package 28, dynamo 30, middle plate 31, starter motor 32, and connection shaft 36.

FIG. 2B illustrates the exploded view that shows the components of the portable equipment smart system adapter. Smart system in a disassembled way that displays the hidden parts of invention, which further includes a pull cord pulley 24 recoil starter handle 27, battery package 28, dynamo 30, middle plate 31, starter motor 32, and connection shaft 36 FIG. 2C illustrates the front external view of the smart equipment adapter. It includes cover 21, cap (with pull cord mechanism) 22, bottom part cover 23, bottom plate (equipment mounting interface) 25, crank 26, control buttons 29, LCD screen 38, GPS antenna 39, camera 40, Hex flange bolt small M10X20X20 41, and crank locking shaft 44.

FIG. 2D illustrates the exploded view of the crank (adapter motion transitional) 26. It includes adjustable connecting shaft 26a, horn 26b, locking shaft 26c/44, latch shaft-gear 26d, and locking mechanism cover 26e.

FIG. 2E illustrates the external side view of smart equipment adapter. It includes, recoil starter handle 27, cap (with pull cord mechanism) 22, adapter cover 21, battery package 28, bottom part cover 23, bottom plate 25, bottom crank 26, and anti-theft key lock 37.

FIG. 2F illustrates the exploded view of the internal parts of bottom part 23. It includes a bottom plate 33, pulley (40T) 34, pulley (20T) 35, collecting rod (Shaft) 36, locking bolt (Male and Female) 37, shaft Spur Gear (2M 34T 20PA 10FW) 42, Starter Spur Gear (2M 17T 20PA 7FW) 43.

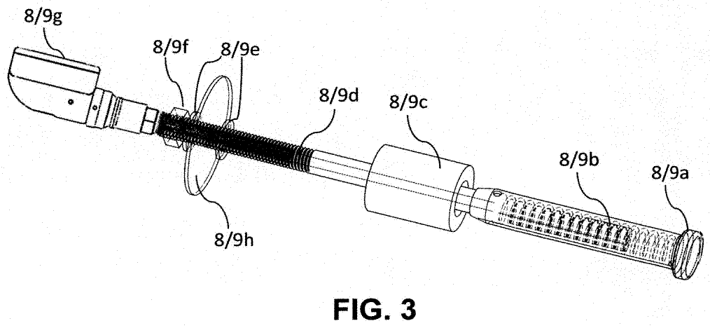

FIG. 3 illustrates the perspective view of oil (8) and gas sensor (9). Which further includes extended part 8/9a, reed sensor 8/9b, floater 8/9c, thread 8/9d, rubber rings 8/9e, nuts 8/9f, pcb and battery housing 8/9g, and oil/gas gap 8/96.

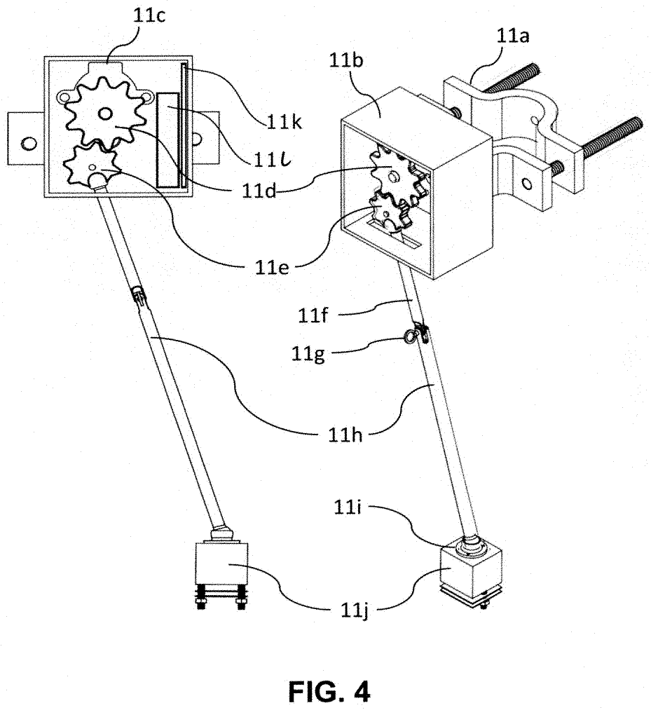

FIG. 4 represents the front and perspective view of chock 11. Which further includes holder 11a, motor box 11b, motor 11c, gear (1) 11d, gear (2) 11e, rod (1) 11f, hinge 11g, rod (2) 11h, ball joint 11i, box 11j, pcb 11k, battery 111.

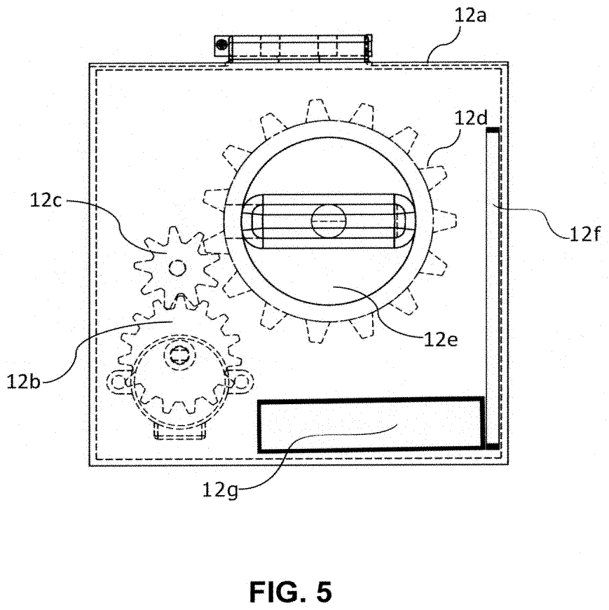

FIG. 5 represents the front view of the fuel gate 12. Which further includes case 12a, motor 12b, gear 12c, adaptor gear 12d, turner (on-off) 12e, pcb 12f, and battery 12g.

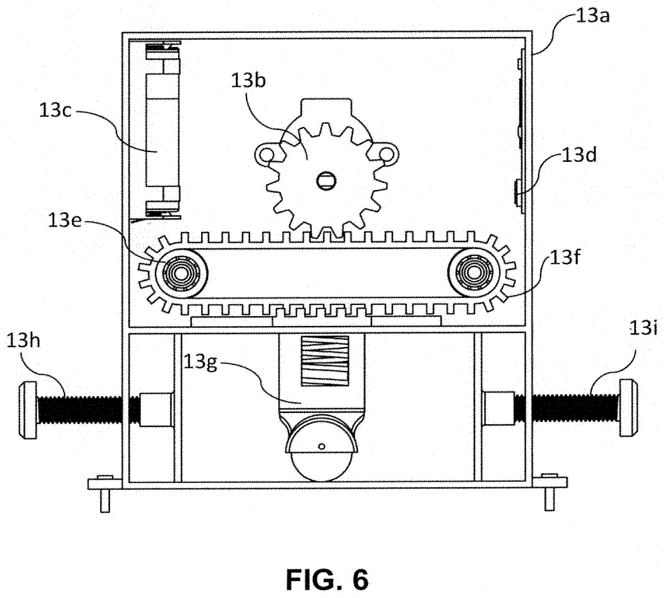

FIG. 6 represents the internal view of the on off switch 13. Case 13a, motor 13b, batteries 13c, PCB 13d, bearing 13e, belt 13f, vehicle shocks system 13g, adjuster/stopper 13h, and rocker adjuster/stopper 13i.

The system is installed on a user's device (such as Personal Computer, Laptop, Tablet, Mobile Phone etc.) in the form of an Application software. This device functions by directly interfacing with the LED display (6) or through phone app while Wi-Fi Adapter (1) enables remote operation. It also uses Wi-Fi, GSM, Z-wave and Bluetooth technology to connect users' device. The Wi-Fi, Z-wave, or Bluetooth in turn command the computing unit of the Master Equipment to do all or either of the following functions as per requirement:
To monitor smoke sensor (2)
To monitor temperature sensor (3)
To monitor vibrate sensor (4)
To Monitor sound sensor (5)
To monitor gas gauge sensor (8)
To monitor oil gauge sensor (9)
Automatically synchronize fuel gate (12) with power off and on (13)
Automatically synchronize choke (11) with power on and power off (13)
To view the environment using the mounted camera (18)
Self-generating energy by using a 24V dynamo (17)
Communicates and control generator transfer and power distribution phase switch

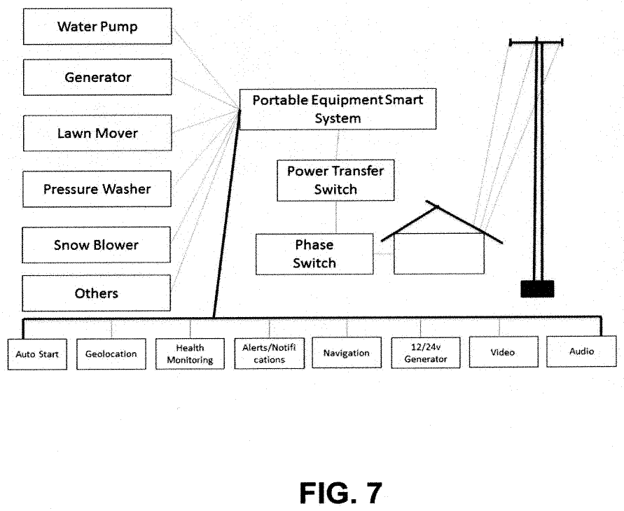

FIG. 7 represents the systematic workflow of the invention and its applications. Which further describes the power switch box (14) detects community power and determine if to supply generator power. When not activated, it will not listen to the switch box (14). In places where homeowners manually switch between power phases, switch controller can also be used for this purpose to enable phase change on user phones via the app. The attachable wheel will provide motion and (remote) navigation and steering to equipment such as mowers, snow blowers etc. System needs at least one controller to function while others are optional. The LCD Display (6) will collect input into the system that will allow operation without an app/device. Overall, the proposed system can be plugged to any generator, water pumps, and lawn mower, etc., to make them smart.

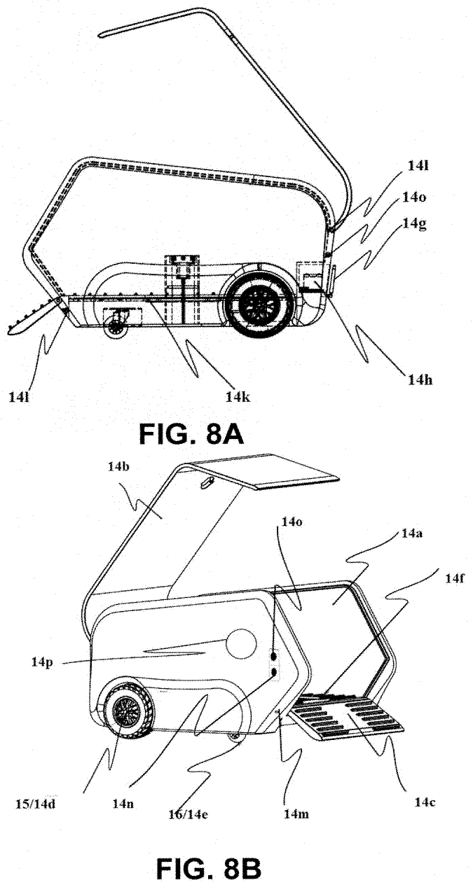

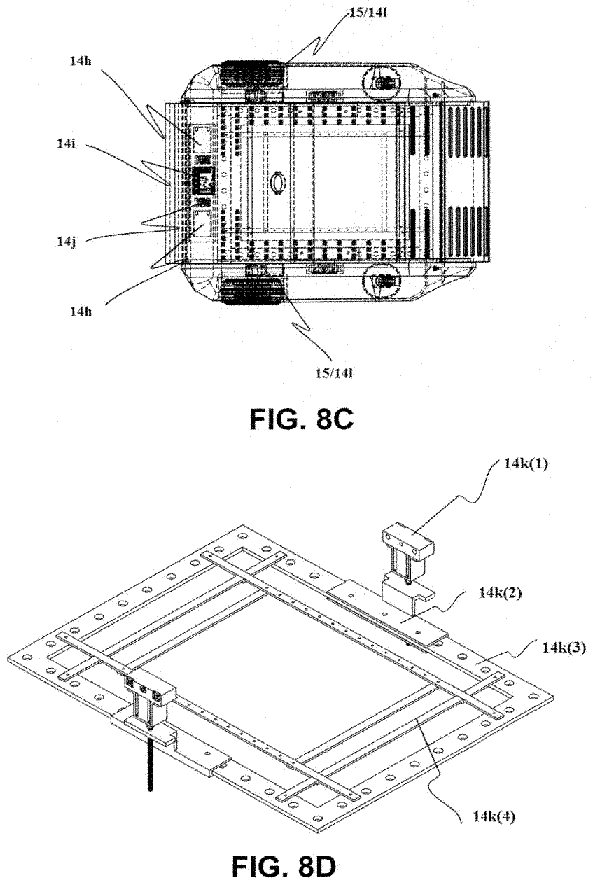

FIG. 8A represents the side view smart wheel in FIGS. 1(14 and 15). Which further includes a RF antenna 14g, batteries 14h, lift mechanism 14k, wheels motor 141, and camera 14o. FIG. 8B represents the perspective view smart wheel in FIGS. 1(14 and 15). Which further includes a body 14a, cover 14b, Gate 14c, rear wheels 15/14d, front wheels 14e, seat plate 14f, door motor 14m, ultrasonic sensor 14n, camera 14o, and speaker 14p.

FIG. 8C represents the front and perspective view smart wheel 14 and 15. Which further includes batteries 14h, pcb 14i, motor driver 14j, and wheels motor 141.

FIG. 8D presents perspective view of the equipment height adjuster. It includes a ball-screw Linear Stage Actuator 14k(1), holder 14k(2), lift seat 14k(3), and portable equipment tire support frame 14k(4).

### DETAILED DESCRIPTION OF INVENTION

The present invention is an Equipment Smart System which is applicable to a majority of non-smart portable equipment. It presents a universal control system which can be plugged into majority of non-smart portable equipment to enable remote operation. It has multiple component interfaces but same functionality to suite different types of equipment. The further components of the system are discussed in the Application below.

One way the present system can be installed on a user's device (such as Personal Computer, Laptop, Tablet, Smart Mobile Phone etc.) in the form of an Application software. They operate the device by directly interfacing with the LED display (6) or through user device app while Wi-Fi Adapter (1) enables remote operations. It also uses Wi-Fi, Transceiver (RF), GSM, Z-wave and Bluetooth technology to connect users' device. The Wi-Fi, GSM, Z-wave, or Bluetooth in turn command the computing unit of the Master Equipment to do all or either of the following functions as per requirement:
To monitor smoke sensor (2)
To monitor temperature sensor (3)
To monitor vibrate sensor (4)
To monitor sound sensor (5)
To monitor gas gauge sensor (8)
To monitor oil gauge sensor (9)
Automatically synchronize fuel gate (12) with power off and on (13)
Automatically synchronize choke (11) with power on and power off (13)
To view the environment using the mounted camera (18)
Self-generating energy by using a 12V dynamo (17)

The present invention has the following advantages (FIG. 7):
Report health of equipment
Ability to automatically send request (repair, maintenance, fuel) request to registered vendors
Ability to schedule power on and/or power off
Ability to notify owners when event happens
Ability to link and manage multiple generators using proposed system in on single user device
Anti-theft functionalities such as self-destruction, gps tracking and using key lock bolt
Resistance to water and extreme weather
Uses Z-wave, GSM (text to control), RF, Wi-Fi, and Bluetooth technology
Ability to use voice control (Alexa compatible)
Ability to play sound such as warnings and alarm
Multiple component interface but same functionality to suite different types of equipment.
Ability to plugin steering components and remotely navigate equipment
Ability to generate its own energy to power the computing unit
Ability for components to communicate wirelessly.

The proposed system is applicable to majority of non-smart portable equipment and can be utilized in one of the following manners:
The power switch box (14) detects community power and determine if to supply generator power. When not activated or connected, it will not listen to the switch box.
In places where homeowners manually switch between power phases, switch controller can also be used for this purpose to enable phase change on user phones via the app.
The attachable wheel will provide motion and (remote) navigation and steering to equipment such as mowers, snow blowers etc. and allow equipment to operate within.
The attachable wheel or robot contains a lift mechanism to enable automatic height adjustment for non-smart portable equipment. It also contain cameras to capture its environment for remote navigation (12f)
System needs at least one controller (mostly the adapter (FIG. 2)) to function while others are optional.
The LED Display (6) will collect input into the system that will allow operation without an app/user device.
The Adapter control button will collect input into the system that will allow operation without an app/user device.
   Overall, the proposed system can be plugged to any generator, water pumps, snow blower, and lawn mower, etc., to make them smart.

The overall system converts non-smart portable equipment to a smart system which provides convenience to the users. The dynamo (17) recharges the battery and provides energy to the PCB (7) and or the smart wheel to enable equipment to operate while reserving the battery energy right after starting up the equipment. The choke (11) component is an optional component of the system but the pcb maintains its interface and will function as expected such as forward and backward movement to shift and return the choke after starting the equipment. The fuel gate (12) component is an optional component of the system but the pcb maintains its interface and will perform as expected functions such as turning to close and open existing fuel gate. The power on/off (13) is an optional component of the system but the pcb maintains its interface and will perform as expected such as turning off and on the power when the component is added. The power switch (14) is an optional and standalone component of the system but the pcb maintains its interface and it will send message to the pcb when activated. The back wheel (15) is an optional component of the system to enable mobility and navigating the equipment to another location without physically moving it. The pcb maintains its interface and it will perform its actions when added. The front wheel (16) it an optional component of the system to enable steering of the equipment, It carries a steering system and motor to enable steering of the equipment. It will perform as expected when added to the system since the pcb maintains its interface. The power phase switch (19) is a standalone component and alternative to power switch box (14). It enables full load while power switch as enable specific appliances. It maintains interface with the pcb and as a result, pcb will receive message from it when connected. The Gas gauge sensor (8) will replace equipment gas gauge to add a way to monitor gas level. It is an optional component but the pcb maintain an interface for it. The oil gauge sensor (9) will replace the equipment oil gauge to add a way to monitor oil level and report status to the pcb. The camera (18) enables users to view the environment of the equipment through the system application. The smoke sensor (2) is a component of the system. The temperature sensor (3) is a component of the system but will report temperature for health purposes to the pcb when added to the system. The vibration sensor (4) is a component of the system and it reports vibration level to the pcb for health purposes. The LED Display (6) will collect input into the system that will allow operation without an app/device. It allows activating and deactivating different component of the system. The adapter system (in FIGS. 2A, 2B, 2C, 2D and 2E) replaces the pull starter kit of generator, mower, water pump etc. with a smarter starter kit (or an adapter) that comprised of starter motor, sensors, dynamo, shafts, pulley, timing belts, crank, and its own pull cord starter.

I/We claim:

1. An Equipment Smart System which is applicable to a majority of non-smart portable equipment which presents a universal control system that can be plugged into majority of non-smart portable equipment and has multiple component interfaces but same functionality to suite different types of equipment.

2. The system as claimed in claim 1 can in one way be installed on a user's device (such as Personal Computer, Laptop, Tablet, etc.) in the form of an Application software and this Application functions by directly interfacing with the PCB and LCD display or through user device app while Wi-Fi Adapter enables remote operation and also uses Wi-Fi, RF, Z-wave, T and Bluetooth technology to connect users' device which in turn command the computing unit of the Master Equipment.

3. The Master Equipment as claimed in claim 2 will manage functions such as to monitor, temperature sensor, to monitor vibrate sensor, to monitor oil gauge sensor, to monitor gas gauge sensor, automatically synchronize fuel gate with power off and on, automatically synchronize choke with power on and power off;

4. The system as claimed in claim 1 can be used to report health of equipment, ability to automatically send request (repair, maintenance, fuel) request to registered vendors, ability to schedule power on and/or power off, ability to notify owners when event happens, ability to link multiple generators using proposed system in on single user device, Anti-theft functionalities such as self-destruction, Resistance to water and extreme weather.

5. The power switch box in the system as claimed in claim 1 detects community power and determines if to supply generator power which when not activated, it will not listen to the switch box.

6. The Control buttons as claimed in claim 2 will collect input into the system that will allow operation without an app/device.

7. The attachable wheel (or robot) to the system will provide motion and (remote) navigation and steering to equipment such as mowers, snow blowers, water pump, leaf blower, etc.
